(19) United States
(12) Patent Application Publication
(10) Pub. No.: US 2025/0010636 A1
(43) Pub. Date: Jan. 9, 2025

(54) IMAGE FORMING APPARATUS AND IMAGE FORMING METHOD

(71) Applicant: Toshiba Tec Kabushiki Kaisha, Tokyo (JP)

(72) Inventor: Hiroyuki KATO, Mishima (JP)

(73) Assignee: Toshiba Tec Kabushiki Kaisha, Tokyo (JP)

(21) Appl. No.: 18/644,038

(22) Filed: Apr. 23, 2024

(30) Foreign Application Priority Data
Jul. 6, 2023 (JP) 2023-111470

(51) Int. Cl. B41J 3/01; G06K 15/02; H04N 1/00

(52) U.S. Cl. CPC B41J 3/01; G06K 15/1848; H04N 1/00334

(57) ABSTRACT

An image forming apparatus includes a controller configured to (a) acquire an image of a document, (b) identify a mark region containing a predetermined mark in the acquired image of the document, (c) decide a variable region containing a variable object that is variable based on an input based on the identified mark region, (d) decide a fixed region indicating a format of the document and containing a fixed object that is not variable, and (e) generate document data based on the decided variable region and the decided fixed region.

### CROSS-REFERENCE TO RELATED APPLICATION

This application is based upon and claims the benefit of priority from Japanese Patent Application No. 2023-111470, filed on Jul. 6, 2023, the entire contents of which are incorporated herein by reference.

### FIELD

Embodiments described herein relate generally to an image forming apparatus and an image forming method.

### BACKGROUND

In the related art, label data such as design of labels is customized when the labels are printed by barcode printers or the like. As customizing methods, applications are generally used as label editing tools on personal computers (PCs). In the label editing tools, lines or characters can be disposed, for example, as in drawing applications of the related art. Label data obtained by editing existing data or newly generated by the label editing tools are transmitted to the barcode printers and are drawn on label sheets or the like by the barcode printers.

### DESCRIPTION OF THE DRAWINGS

FIG. 1 is a diagram schematically illustrating an image forming system according to an embodiment;

FIG. 2 is a block diagram illustrating a hardware configuration of an image forming apparatus;

FIG. 3 is a block diagram illustrating a hardware configuration of a barcode printer;

FIG. 4 is a block diagram illustrating a functional configuration of the image forming apparatus;

FIG. 5 is a block diagram illustrating a functional configuration of the barcode printer;

FIG. 6 is a diagram illustrating a label including no variable object;

FIG. 7 is a diagram illustrating label data of the label illustrated in FIG. 6;

FIG. 8 is a diagram illustrating a label including variable objects;

FIG. 9 is a diagram illustrating label data of the label illustrated in FIG. 8;

FIG. 10 is a flowchart illustrating an image forming process;

FIG. 11 is a diagram illustrating a printed label;

FIG. 12 is a diagram illustrating the label illustrated in FIG. 11 in which marks are written;

FIG. 13 is a diagram illustrating variable regions;

FIG. 14 is a diagram illustrating fixed regions; and

FIG. 15 is a flowchart illustrating an operation of the barcode printer.

### DETAILED DESCRIPTION

In general, an exemplary embodiment provides a technique capable of easily generating label data from a document.

In general, according to one embodiment, an image forming apparatus includes a controller configured to (a) acquire an image of a document, (b) identify a mark region containing a predetermined mark in the acquired image of the document, (c) decide a variable region containing a variable object that is variable based on an input based on the identified mark region, (d) decide a fixed region indicating a format of the document and containing a fixed object that is not variable, and (e) generate document data based on the decided variable region and the decided fixed region.

Hereinafter, an embodiment will be described with reference to the drawings. In each drawing, the same configurations are denoted by the same reference signs.

### Configuration of Image Forming System

A configuration of an image forming system according to an embodiment will be described.

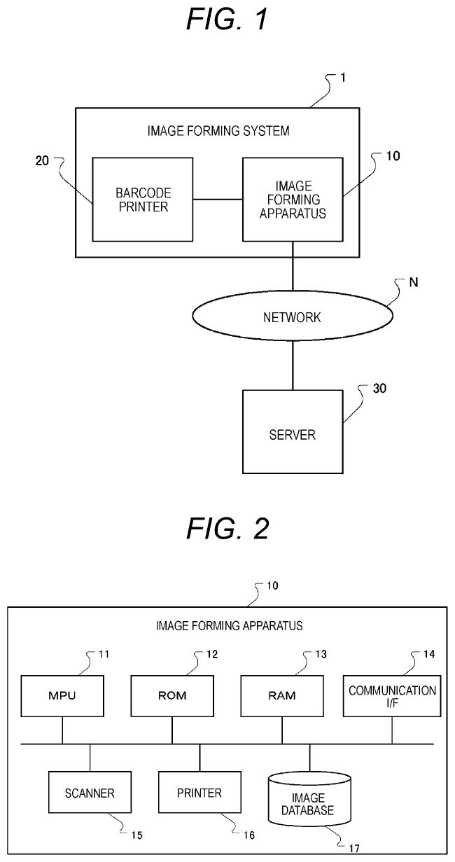

FIG. 1 is a diagram schematically illustrating an image forming system according to an embodiment.

As illustrated in FIG. 1, an image forming system 1 according to the embodiment includes an image forming apparatus 10 and a barcode printer 20.

The image forming apparatus 10 takes a document on which characters such as numbers, words, or sentences, a striped barcode or 2-dimensional barcode, frame lines partitioning the characters or the barcodes, and the like are printed as a document image and generates document data from the document image. Examples of the image forming apparatus 10 include a multifunction peripheral (MFP) (e.g., including a printer) capable of printing read document data on a sheet or transmitting read document data to an external apparatus such as the barcode printer 20 or a server 30 via a network N. In the embodiment, a document read by the image forming apparatus 10 is assumed to be a label attached to a commodity or a packing box in description. Accordingly, the image forming apparatus 10 reads a label and generates label data (e.g., document data) from image data of the label. The image forming apparatus 10 can use various printed sheet-shaped objects such as receipts or tickets as documents without being limited to labels.

The image forming apparatus 10 is connected to be able to perform data communication with the barcode printer 20 via a wired or wireless communication scheme (e.g., through a communication circuit or communication interface). Examples of the wired communication scheme include an Ethernet (registered trademark), USB, IEEE1394 [FIREWIRE (registered trademark)], and LIGHTNING (registered trademark). Examples of the wireless communication scheme include short-range wireless communication such as near field communication (NFC) or Bluetooth (registered trademark), a cellular scheme, and Wi-Fi.

The barcode printer 20 forms an image on a sheet that is a recording medium according to an electrographic scheme, an inkjet scheme, a thermal transfer scheme, or the like. In the embodiment, a printing target sheet is a label on which an image is not formed. In the barcode printer 20, the label is stored as a label sheet with a roll shape in which a plurality of labels are bonded. The barcode printer 20 does not require a special infrastructure such as a personal computer (PC) and is a standalone printer capable of performing printing by acquiring input information from an input apparatus that is an external apparatus alone and reflecting the input information in label data. Examples of the input apparatus include a PC, a code reader, a scanner, a measurer, a thermometer, a multifunction peripheral, and a server. Examples of the input information include a 2-dimensional barcode read by a code reader, image information read by a scanner, a weight of a measurement target measured by a measurer, a temperature measured by a thermometer, and information acquired via the network N.

When the input information is acquired, the barcode printer 20 forms an image on a label by reflecting the input information in format data stored in advance. The barcode printer 20 according to the embodiment acquires label data including format data from the image forming apparatus 10 and forms an image on a label on a label sheet based on the label data. Details of the label data according to the embodiment will be described.

In the embodiment, the image forming apparatus 10 is connected to be able to perform data communication with the server 30 that is a cloud server serving as an external apparatus via the network N. The server 30 may be a cloud server. The image forming apparatus 10 can transmit the generated label data via the network N.

### Hardware Configuration

Next, hardware configurations of the image forming apparatus 10 and the barcode printer 20 will be described. FIG. 2 is a block diagram illustrating a hardware configuration of the image forming apparatus according to the embodiment.

As illustrated in FIG. 2, the image forming apparatus 10 includes a micro processing unit (MPU) 11, a read only memory (ROM) 12, a random access memory (RAM) 13, a communication interface (IF) 14, a scanner 15, a printer 16, and an image database 17.

The MPU 11 loads various programs such as a basic input/output system (BIOS), an operating system (OS), and a general-purpose application read from the ROM 12 that is a nonvolatile storage region, and a program for performing an image forming process (an image forming method) to be described below on the RAM 13 that is a volatile storage region and executes the programs. The communication IF 14 is used for communication with the server 30 via the barcode printer 20 or the network N.

The scanner 15 takes a label as an image (for example, an RGB image) by emitting light from an emitter toward the label placed on a document platen such as a glass plate, receiving light reflected from the document platen, and converting the light into electronic data. The printer 16 forms an image on a sheet serving as a recording medium by an electrographic scheme, an inkjet scheme, a thermal transfer scheme, or the like. Examples of the image include an image taken by the scanner 15 and data acquired from an external apparatus. The image database 17 stores label data generated through an image forming process to be described below in addition to image data taken by the scanner 15.

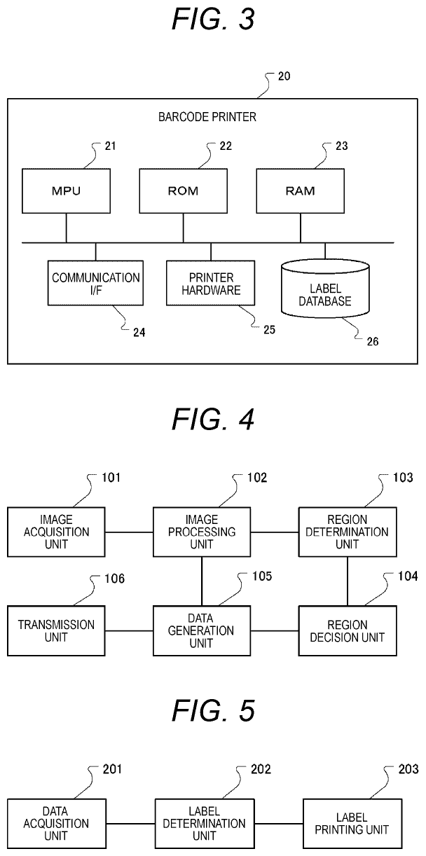

FIG. 3 is a block diagram illustrating a hardware configuration of a barcode printer according to the embodiment.

As illustrated in FIG. 3, the barcode printer 20 includes an MPU 21, a ROM 22, a RAM 23, a communication IF 24, printer hardware 25, and a label database 26.

The MPU 21 loads various programs such as a BIOS, an OS, and a general-purpose application read from the ROM 22 that is a nonvolatile storage region on the RAM 23 that is a volatile storage region and executes the programs. The communication IF 24 is used for communication with the image forming apparatus 10.

The printer hardware 25 is hardware that performs printing on a label sheet and includes, for example, a platen motor that drives a platen roller, a printing head that includes a heating element, and a cutter unit that cuts the label sheet. The printer hardware 25 is controlled by the MPU 21. The label database 26 stores label data acquired from the image forming apparatus 10.

### Functional Configuration

Next, a functional configuration of the image forming apparatus 10 will be described. FIG. 4 is a block diagram illustrating a functional configuration of the image forming apparatus according to the embodiment.

As illustrated in FIG. 4, the image forming apparatus 10 includes an image acquisition unit 101, an image processing unit 102, a region determination unit 103, a region decision unit 104, a data generation unit 105, and a transmission unit 106 as functions. The functions are implemented in cooperation with the hardware of the above-described image forming apparatus 10.

The image acquisition unit 101 acquires a label image (e.g., a document image) that is an image of a label using the scanner 15 and stores the label image in the image database 17. The image processing unit 102 performs predetermined image processing such as inclination correction, color conversion, and filter processing on the label image. The region determination unit 103 determines whether there is a mark region in the label image and whether a variable object is a character string. The mark region will be described below.

The region decision unit 104 decides (e.g., identifies) a variable region in the label image and decides (e.g., identifies) a fixed region in the label image. The variable region and the fixed region will be described below. The data generation unit 105 generates label data based on the decided variable region and the decided fixed region. The transmission unit 106 transmits the label data generated by the data generation unit 105 to the barcode printer 20, the server 30, or the like.

Next, a functional configuration of the barcode printer 20 will be described. FIG. 5 is a block diagram illustrating a functional configuration of the barcode printer according to the embodiment.

As illustrated in FIG. 5, the barcode printer 20 includes a data acquisition unit 201, a data determination unit 202, and a label printing unit 203 as functions. The functions are implemented in cooperation with the hardware of the above-described barcode printer 20.

The data acquisition unit 201 acquires the label data generated from the image forming apparatus 10 and stores the label data in the label database 26. The data determination unit 202 determines whether the data acquired by the data acquisition unit 201 is label data, input information from an input apparatus, or the like. The label printing unit 203 prints a label based on the input information and/or the label data stored in the label database 26.

### Label Data

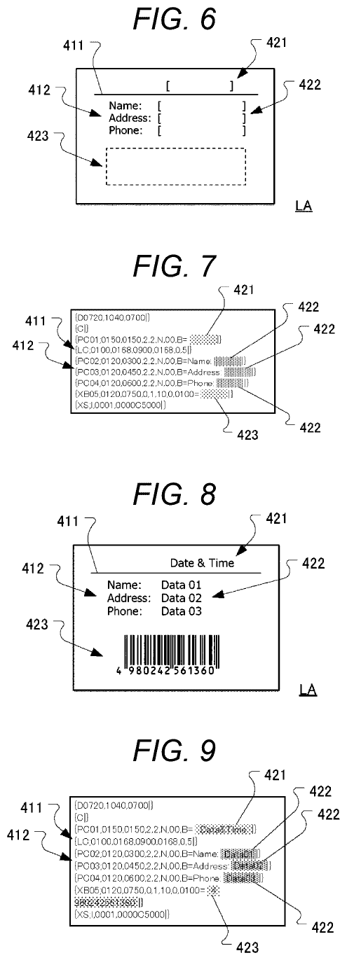

Next, label data will be described in detail. FIG. 6 is a diagram illustrating a label including no variable object. FIG. 7 is a diagram illustrating label data of the label illustrated in FIG. 6.

As illustrated in FIG. 6, many fixed objects 411 and 412 are drawn in a label LA according to the embodiment. The fixed object 411 is drawn as a frame line extending in the horizontal direction.

The fixed objects 412 are each drawn as characters (e.g., letters) spelling out words such as Name, Address, and Phone. Regions where the fixed objects 411 and 412 are shown are fixed regions indicating a basic format (label format) of the label LA. The fixed objects 411 and 412 described here are exemplary and various characters such as numbers, words, sentences, signs, and the like or frame lines can be used as fixed objects. The fixed objects may include character strings describing a variable object (e.g., a fixed object “Name” describing the content and location of a variable object where a name will be inputted).

Regions 421 to 423 are variable regions where variable objects are drawn. The variable objects are input or changed appropriately according to a label-attached target such as characters such as a number, a word, a sentence, or a sign or a figure including an image code such as a striped barcode or a 2-dimensional code. In other words, the variable objects 421 to 423 are input information from an external input apparatus and the variable regions can be said to be regions where the input information is input.

The label data according to the embodiment is data obtained by converting the label LA illustrated in FIG. 6 into character string data illustrated in FIG. 7. Specifically, the label data is converted into printing commands that are a set of parameters and indicate locations and content (characters, figures, or the like) in the label LA. The data converted into the printing command becomes label data. Hatching portions illustrated in FIG. 7 indicate variable regions where the variable objects are input, that is, regions corresponding to each of the printing commands. Here, the hatching portions are, of course, blank. In the example illustrated in FIG. 7, the variable object 421 is input in the third printing command from the top. The corresponding variable objects 422 are input in the fifth to seventh printing commands from the top. The variable object 423 is input in the eighth printing command from the top.

The variable objects include variable objects to which data is automatically allocated according to input information and variable objects to which data is manually allocated by a user using an apparatus such as a PC. For example, it is assumed that label data including variable objects to which data is automatically allocated is generated and stored in the label database 26 of the barcode printer 20. Here, when the input information read and transmitted by the barcode reader is acquired, corresponding information included in the input information can be allocated in the variable objects to which the data is automatically allocated without involving manpower. In the label data illustrated in FIG. 7, input information from the input apparatus is automatically allocated in the variable objects 421 and 423 and information is input by the user in the variable objects 422.

A difference between the objects occurs according to whether automatic allocation of the input information is set in advance. Specifically, after the label data is generated, the automatic allocation of the input information can be set by editing the label data. For example, selection of an input apparatus using the label data (association of the label data with the input apparatus), which information included in the input information is automatically allocated to which variable region of the label data, and the like are set. The editing may be separately executed by the user of the image forming apparatus 10 or the barcode printer 20.

FIG. 8 is a diagram illustrating a label including variable objects. FIG. 9 is a diagram illustrating label data of the label illustrated in FIG. 8.

As illustrated in FIG. 8, when the variable objects 421 to 423 are included in the label LA, the variable objects 421 to 423 corresponding to the respective printing commands are input in the label data illustrated in FIG. 9. The barcode printer 20 can produce the label LA illustrated in FIG. 8 based on the label data in which the variable objects 421 to 423 are input.

### Image Forming Process

Next, an image forming process by the image forming apparatus 10 will be described in detail. FIG. 10 is a flowchart illustrating the image forming process according to the embodiment. The image forming process according to the embodiment is triggered when a label is set on the document platen included in the scanner 15 of the image forming apparatus 10 and scanning of an image is performed. In addition to a button for “execution of scanning”, for differentiation from normal scanning, a button for “execution of label generation scanning” to perform the image forming process is preferably displayed to be selectable on a display (not illustrated) of the image forming apparatus 10.

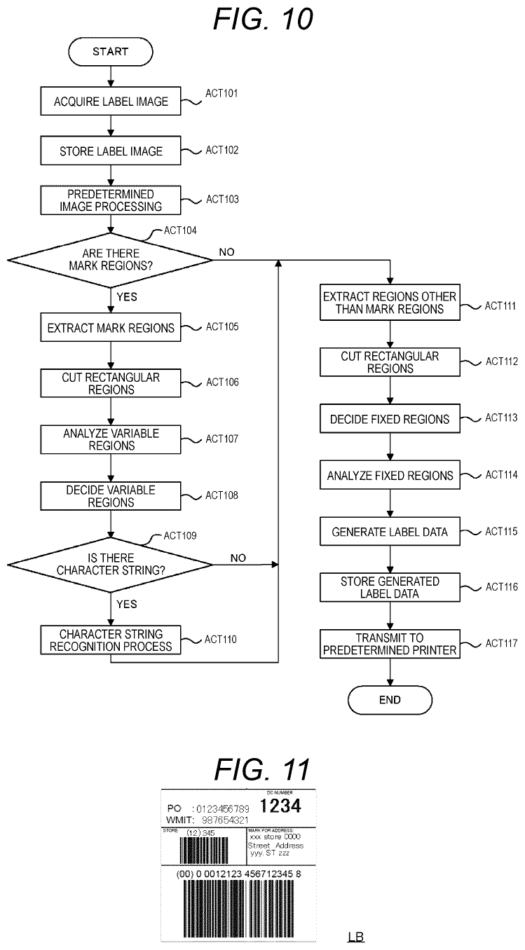

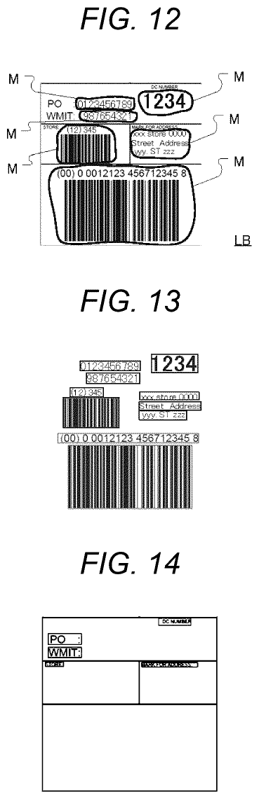

Before the image forming process, first, the user writes marks at portions desired to be recognized as variable regions by the image forming apparatus 10. The marks in the embodiment are handwritten marker lines and the portions desired to be variable regions are surrounded by the marker lines. For example, when a label LB illustrated in FIG. 11 is a label desired to be label data, as illustrated in FIG. 12, the user writes mark regions M by surrounding the portions desired to be recognized as variable regions by the image forming apparatus 10 by marker lines. Here, the marker lines preferably have chromatic color such as red different from the lines such as frame lines in the label. When the marker lines have chromatic color, the image forming apparatus 10 can easily determine that the mark regions M surrounded by the marker lines are the variable regions.

When the label LB in which the marks are written is scanned, the image acquisition unit 101 acquires a label image of the label LB (ACT101) and stores the label image in the image database 17 (ACT102). After the label image is stored, the image processing unit 102 performs the above-described predetermined image processing on the label image (ACT103) to correct the label image. After the image processing, the region determination unit 103 determines whether the mark regions M are included in the corrected label image (ACT104). In the embodiment, whether the mark regions M are included is determined according to whether there are regions surrounded by the marker lines with the predetermined chromatic color, as described above. For example, the region determination unit 103 determines the chromatic color in the label image by determining whether a value of |R−G| or |G−B| for each pixel in the label image is equal to or greater than a threshold. Predetermined chromatic color may be determined when color is converted in L*a*b* color space and is included in a region of preset chromatic color. When the mark regions M are included in the corrected label image (YES in ACT104), the region decision unit 104 extracts the mark regions M (ACT105).

Specifically, the region decision unit 104 detects regions based on the outer contours of the marker lines forming the mark regions M (regions of outermost contours). For example, the region decision unit 104 detects regions along the contour lines of the mark regions M. After the detection, the region decision unit 104 extracts the detected regions as the mark regions M. Accordingly, the region decision unit 104 can detect the regions surrounded by the marker lines by the user precisely and can extract an image of a region intended by the user.

There is a possibility of the frame lines being included in the mark regions M unintentionally. Therefore, when a part of a set of straight dots is included in the mark region M and extends outside of the mark region M, it may be determined whether a length (the number of dots) of an extension portion exceeds a predetermined threshold. When the length (the number of dots) of the extension portion exceeds the predetermined threshold, the part is determined as a fixed object and is excluded from a rectangular region. The predetermined threshold is preferably set to a value at which a striped barcode is not excluded from the rectangular region.

After the mark regions M are extracted, the region decision unit 104 cuts (e.g., crops) the rectangular regions based on the objects in the extracted mark regions M (variable objects) (ACT106). The rectangular regions may be cut using a scheme of the related art. A set of black pixels with an interval equal or less than a predetermined number of white pixels (pixels of background color) may be recognized as a character string, and an outermost contour of the character string or a figure may be set as a rectangular region.

There is a possibility of an unintended plurality of rectangular regions being cut in one mark region M. To avoid the cutting of the unintended plurality of rectangular regions, a threshold of the number of dots lain between two adjacent rectangular regions is preferably set in advance. For example, when the number of dots lain between the two rectangular regions is less than the threshold, the two rectangular regions are determined as unintentionally divided rectangular regions and are considered to be one rectangular region.

After the rectangular regions are cut, the region decision unit 104 analyzes the cut rectangular regions (ACT107) and decides that the analyzed rectangular regions are the variable regions (ACT108). Through the image analysis, positions (coordinate positions) in label images of at least the rectangular regions are obtained. Through the image analysis, it is identified whether a variable object forming each rectangular region is a character string, whether the variable object is a figure, or whether the variable object is an image code. For the image analysis, an image analysis process of the related art may be used, and thus detailed description thereof will be omitted. An analysis result is preferably stored in association with a label image in the image database 17 by the region decision unit 104. FIG. 13 illustrates the decided variable regions.

After the variable regions are decided, the region determination unit 103 determines, from the analysis result, whether the variable object of the variable region is a character string (ACT109). When it is determined that the variable object is the character string (YES in ACT109), the image processing unit 102 performs a character recognition process of the related art, such as optical character recognition (OCR) and recognizes the character string (ACT110).

After the character string is recognized, the region decision unit 104 extracts regions other than the mark regions M, in other words, the variable regions, from the corrected label image (ACT111). After the extraction, the region decision unit 104 cuts the rectangular regions based on the objects in the extracted regions (fixed objects) (ACT112). A method of cutting the rectangular regions may be similar to a method of cutting the rectangular regions related to the variable regions. After the rectangular regions are cut, the region decision unit 104 performs image analysis on the cut rectangular regions (ACT113) and decides the analyzed rectangular regions as the fixed regions (ACT114). FIG. 14 illustrates the decided fixed regions. A method for the image analysis may be similar to an analysis method for the rectangular regions related to the variable regions.

After the fixed regions are decided, the data generation unit 105 generates the label data based on the decided variable regions and the decided fixed regions (ACT115). The label data generated here is generated as printing commands including coordinates of the variable regions and the fixed regions, as described above. For example, a corresponding variable region is allocated to each fixed region according to each of the stored analysis results, particularly the coordinates. Since the label data here is so-called format data, as illustrated in FIG. 7, the variable objects are not included in the variable regions. Accordingly, ACT109 in which it is determined whether the variable object is a character string or ACT110 in which character recognition such as OCR is performed may be omitted. Label data including a variable object may be generated separately.

After the label data is generated, the transmission unit 106 transmits the label data to a preset printer, here, the barcode printer 20 (ACT117). Then, the process ends. Conversely, when it is determined in ACT109 that the variable object is not a character string (NO in ACT109), the process proceeds to ACT111. When it is determined in ACT104 that no mark region M is included in the corrected label image (NO in ACT104), similarly, the process proceeds to ACT111. Here, since the variable region is not included in the label data, the image forming apparatus 10 may inform the user of an error and may generate label data in which the variable region is not included.

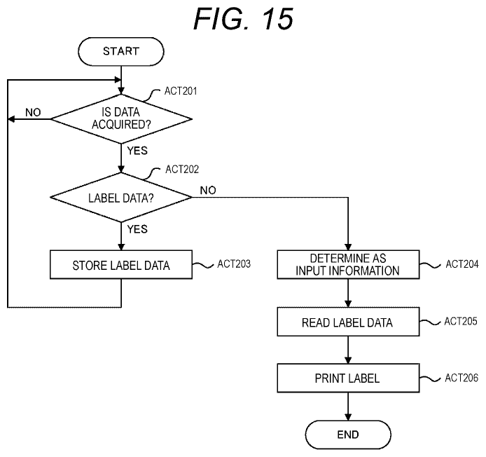

An operation of the barcode printer 20 to which the label data is transmitted will be described simply. FIG. 15 is a flowchart illustrating an operation of the barcode printer 20 according to the embodiment. The process is triggered when data is acquired from the image forming apparatus 10 or the input apparatus.

First, the data determination unit 202 determines whether the data acquisition unit 201 acquires predetermined data (ACT201). The predetermined data is label data or input information transmitted from the input apparatus. When the predetermined data is not acquired (NO in ACT201), the data determination unit 202 determines again whether the data acquisition unit 201 acquires the predetermined data after a predetermined time passes.

Conversely, when the predetermined data is acquired (YES in ACT201), the data determination unit 202 determines whether the acquired predetermined data is label data (ACT202). When the acquired predetermined data is label data (YES in ACT202), the data determination unit 202 stores the acquired label data in the label database 26 (ACT203). After the label data is stored, the process proceeds to the determination process of ACT201.

Conversely, when the acquired data is not label data (NO in ACT202), the data determination unit 202 determines that the acquired data is input information from the input apparatus (ACT204). Subsequently, the label printing unit 203 reads the label data corresponding to the input apparatus indicated by the input information from the label database 26 (ACT205). After the label data is read, the label printing unit 203 appropriately reflects (allocates) the input information in the read label data and prints the label (ACT206). Then, the process ends. The label data of the input information may be reflected by the user of the barcode printer 20, or automatic allocation may be set through editing of the label data in advance and the label data may be reflected based on the automatic allocation.

Editing of the label data will be described simply. The label data transmitted to the barcode printer 20 and stored in the label database 26 is appropriately edited by an apparatus such as a PC that can access label data on the barcode printer 20 or inside the barcode printer 20 by the user.

Examples of the editing include selection of an input apparatus using the label data (association of the label data with the input apparatus). Examples of the editing include addition of a character or a figure and definition regarding which information included in the input information is automatically allocated to which variable region of the label data.

The label data may be edited by the user of the image forming apparatus 10 before the label data is transmitted. For example, after the label data is generated, the label data in the barcode printer 20 is not transmitted automatically and the image forming process ends. After the image forming process ends, the user operates the image forming apparatus 10 to edit the label data in the image forming apparatus 10 or edits the label data by operating an apparatus such as a PC that can access the label data. After the editing, the label data edited manually by the user is transmitted to the barcode printer 20 or the server 30.

According to the above-described embodiment, it is possible to easily generate label data from an already printed label. Here, the label data can include variable regions and fixed regions that are distinguished from each other. Accordingly, it is easy for the user to edit the label data. The label data generated in cooperation between the image forming apparatus 10 and the barcode printer 20 can be automatically transmitted to the barcode printer 20.

In the above-described embodiment, the region determination unit 103 determines that the regions surrounded by the lines with the predetermined chromatic color are the mark regions M. However, the color may not be determined and regions surrounded by lines with predetermined elliptical shapes may be determined to be the mark regions M.

The automatic allocation of the input information in the variable regions in the label data may be added to the label data or may be set in the barcode printer 20 so that the editing is not performed and predetermined information is automatically allocated in advance. For example, the region determination unit 103 of the image forming apparatus 10 determines, from the analysis result, whether an attribute of the variable object (for example, a date) is an automatic allocation target. When the attribute is determined to be an automatic allocation target, the data generation unit 105 embeds, in the label data, a setting such as automatic rewriting by information (for example, a date) regarding the same attribute in which the variable object is included in the input information. Alternatively, information regarding the setting may be transmitted to the barcode printer 20 along with the label data. According to the attribute of the variable object, for example, it is determined whether the automatic allocation is to be performed. However, the automatic allocation may be set in a variable region related to a predetermined printing command. The variable object in which the automatic allocation is to be set may be distinguished, for example, by causing color of lines serving as marker lines to be different and/or distinguishing regions surrounded by lines and regions painted with markers.

The barcode printer 20 according to the embodiment is embedded in the image forming system 1, but any printer may be used as long as the printer is capable of acquiring label data from the image forming apparatus 10 and printing a label based on the label data. The barcode printer 20 according to the embodiment is a so-called label printer, as described above. However, any printer may be used as long as the printer is capable of acquiring label data (document data) generated by the image forming apparatus 10 and performing printing based on the label data. For example, the printer may be a receipt printer or a multifunction peripheral similar to the image forming apparatus 10. The barcode printer 20 may acquire the label data via the network N.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
a controller configured to:
acquire an image of a document;
identify a mark region containing a predetermined mark in the acquired image of the document;
decide, based on the identified mark region, a variable region containing a variable object that is variable based on an input;
decide a fixed region indicating a format of the document and containing a fixed object that is not variable; and
generate document data based on the decided variable region and the decided fixed region.

2. The image forming apparatus of claim 1, wherein the controller is configured to decide the fixed region to be a region other than the mark region in the image of the document.

3. The image forming apparatus of claim 1, wherein the predetermined mark is a line, and wherein the controller is configured to determine that a region surrounded by the line is the mark region.

4. The image forming apparatus of claim 3, wherein the controller is configured to determine that the fixed region is a region that is not surrounded by the line.

5. The image forming apparatus of claim 3, wherein the controller is configured to identify the mark region in response to a determination that the line has a predetermined color.

6. The image forming apparatus of claim 1, wherein the predetermined mark has a predetermined shape.

7. The image forming apparatus of claim 1, wherein the predetermined mark has a predetermined color.

8. The image forming apparatus of claim 1, wherein the variable object includes a character string.

9. The image forming apparatus of claim 1, wherein the variable object includes at least one of a figure or an image code.

10. The image forming apparatus of claim 1, wherein the fixed object includes a character string describing the variable object.

11. The image forming apparatus of claim 1, further comprising a communication circuit configured to transmit the document data generated by the controller to an external apparatus.

12. The image forming apparatus of claim 1, further comprising a scanner configured to scan the document and generate the image of the document.

13. The image forming apparatus of claim 1, further comprising a scanner configured to scan the document and generate the image of the document.

14. An image forming method for an image forming apparatus, the image forming method comprising:
acquiring an image of a document;
identifying a mark region within the acquired image of the document based on a predetermined mark;
deciding, based on the identified mark region, a variable region containing a variable object;
deciding a fixed region indicating a format of the document, the fixed region being a region of the image of the document other than the mark region; and
generating document data based on the decided variable region and the decided fixed region.

15. The image forming method of claim 14, further comprising forming an output image on a sheet based on the generated document data.

16. The image forming method of claim 15, wherein the output image is a first output image and the sheet is a first sheet, further comprising:
subsequent to forming the first output image on the first sheet, updating the variable object; and
forming a second output image on a second sheet based on the updated variable object.

17. The image forming method of claim 14, wherein the predetermined mark is a line, and wherein identifying the mark region includes determining that a region surrounded by the line is the mark region.

18. The image forming method of claim 17, wherein the line has a predetermined color.

19. An image forming method for an image forming apparatus, the image forming method comprising:
acquiring an image of a document, the acquired image including a first object having a first color, a second object, and a mark having a second color;
identifying a variable region based on the mark in response to a determination that the second color is different than the first color;
updating the second object in response to a determination that the second object is within the variable region; and
forming an output image on a sheet, the output image including the first object and the updated second object.

20. The image forming method of claim 19, wherein the mark includes a line surrounding the second object.
